(19) United States
(12) Patent Application Publication
(10) Pub. No.: US 2011/0073137 A1
(43) Pub. Date: Mar. 31, 2011

(54) Shower Sanitization System and Apparatus

(76) Inventors: John James Dvorak, Monroe, CT (US); Mildred Blanche Mendelson, Pound Ridge, NY (US)

(21) Appl. No.: 12/845,093

(22) Filed: Jul. 28, 2010

Related U.S. Application Data
(60) Provisional application No. 61/277,606, filed on Sep. 28, 2009.

(51) Int. Cl. B08B 9/027

(52) U.S. Cl. 134/22.11; 134/166 C

(57) ABSTRACT

An improved shower or plumbing sanitizing system is provided by a showerhead adapter and/or tap port configured to mount between a water supply stub and an outlet such as a showerhead, hose or faucet and which delivers and imparts a cleansing or sanitizing agent, particularly liquid sanitizer, to the plumbing components prone to infestation with opportunistic bacteria.

### CROSS-REFERENCE TO RELATED APPLICATION

This application claims the benefit of provisional application Ser. No. 61/277,606 filed Sep. 28, 2009 and which is incorporated herein by reference.

### FIELD OF THE INVENTION

The present invention relates to sanitization improvements for shower systems and related plumbing applications.

### BACKGROUND OF THE INVENTION

The inside of a showerhead is an ideal breeding ground for infectious bacteria. Researchers have identified various microorganisms, including mycobacterium avium, which is known to potentially cause health problems in people who are elderly, pregnant, or otherwise have compromised immune systems. When the shower is turned on, these pathogens not only mix with the bathing water but also become suspended in the air, attached to water droplets. In addition, in use a biofilm is formed on the showerhead parts and accessory parts. When the shower is turned on, various disease-causing microorganisms are released by the water from the biofilm and in addition to mixing with the water, become suspended in the air. Aside from coating articles and surfaces in the bathroom, from towels to toothbrushes, the pathogens can easily be inhaled deeply into the lungs.

The problem arises because the inside of a showerhead or similar plumbing fixture is nearly impossible to thoroughly clean. Most showerheads cannot be readily disassembled and the suggested methods of cleaning, which involve removing the showerhead and boiling it or soaking it in a cleanser are impractical for most people to do on a regular basis.

These and other problems are addressed with the subject sanitizing method and apparatus, which provides a shower sanitizer system that allows the consumer to directly inject cleaner or sanitizer into the showerhead without having to remove it. This method ensures a more thorough distribution of the cleaning solution to the internal parts of the shower hose and head assembly than other methods of cleaning The end result is a cleaner, safer shower and bathroom. The simplicity and ease of this system will encourage people to clean their showerheads more frequently, and therefore provide greater peace of mind about the health of their family.

In addition to home use, this shower sanitizing system can by used in gymnasiums, hospitals, rehabilitation centers and facilities that cater to people with compromised immune systems. It would also find utility in the hotel industry where present day guests have begun to investigate Internet reviews discussing cleanliness of the properties, and knowledgeable guests are already interested in added value amenities such as special pillows, sheets, and mattresses. Consumers have a heightened awareness of the bacteria and germs in their lives. Those susceptible to infection need to know that something as simple as taking a shower is safe. And those not as susceptible will take satisfaction in knowing that they can easily and thoroughly eliminate bacteria from a part of their home that the family uses every day.

### SUMMARY OF THE INVENTION

The product is a plumbing adapter and/or tap port that fits between the showerhead and water pipe. For ease of installation, in one embodiment, the plumbing adapter can be hand-installed using a simple rubber washer. To start the sanitizing process, the consumer attaches a tube from a bottle of cleaning solution to a one-way flow port on the adapter. This tube attachment can be a screw-on fitting or a ¼ turn engagement for ease of use. After the water is turned on, the cleaning solution is either drawn up the tube and through the adapter as a result of the water pressure, or it may be pumped in via a spray pump on the bottle of solution. A safe and effective cleaning solution will be used, but optionally a marking dye or foaming agent may be added to let consumers know when the entire cleaning agent is out of the showerhead before bathing. After a one-time purchase and installation of the adapter, the cleansing solution would be an ongoing, repurchased product for the system.

A method of cleaning and sanitizing a shower system by providing an easy way for a user to inject a cleansing solution into the water flow upstream of the shower hose or head. This would ensure a more thorough distribution of the cleansing solution to all the internal parts of the shower hose or head assembly. This is to address the constant build up of germs, molds and mildews that develop in a shower system and come out in the water onto the user and into the air. Many people are sensitive to these germs and everyone would want to know that they are showering in clean water. This system would also be valuable to hotel chains, etc for obvious reasons.

An improved sanitization system and a variety of preferred embodiments are provided herein below.

The subject improved sanitization system may be made and used in accordance with the methods detailed below.

Other objects, features and advantages of the present invention will be apparent when the detailed descriptions of the preferred embodiments of the invention are considered with reference to the accompanying drawings, which should be construed in an illustrative and not limiting sense as follows.

### BRIEF DESCRIPTION OF THE DRAWINGS

FIG. 1 is schematic representation of an embodiment of the subject sanitizing system.

FIGS. 2a-d are perspective views of another embodiment of the subject sanitization system.

FIG. 3 is a perspective view of an alternative adapter, which may be used in another embodiment of the subject system.

FIGS. 4a and 4b are perspective views of alternative adapters, which may be used in other embodiments of the subject sanitization system.

FIG. 5a is an end view of a pierce tap which may be used in another embodiment of the subject system.

FIG. 5b is a perspective view of a shower stub combined with the pierce tap shown in FIG. 5a.

### DETAILED DESCRIPTION OF THE PREFERRED EMBODIMENTS

The subject improved sanitization apparatus has several important elements as detailed herein below.

There is provided a system comprising an adapter that is configured to mount on a conventional shower stub coming out of a wall. The showerhead or hose would then attach to the adapter. While the sanitization apparatus is described as comprising the adapter, a tap port may be substituted for the adapter with equally good results.

In one embodiment of the subject system, the sanitizing apparatus is comprised of an adapter having standard shower plumbing dimensions and materials and which also provides a tap fitting to which a tube with the appropriate connector would mate to. The tap fitting and connector is generally cylindrical and configured to allow cleansing or sanitizing solution to flow through them when the connector is attached. Further, the port will be sealed shut when the connector is removed; this connection is to be designed for simple hand operation.

In one embodiment, the tube is also connected to a bottle of cleansing or sanitizing solution. When the shower water is turned on, the water stream will draw the solution up and into the water supply. Alternatively, the bottle could incorporate a hand pump, such as on a spray bottle, that would positively inject the solution into the water stream. Any method of delivering the solution to the tap would suffice.

The sanitizing or cleansing solution is to be designed to be effective and safe, should any residual amount remain in the showerhead, and could have an indicator, such as a dye marker or foaming agent added to it to indicate when it is being utilized, and also when it has been rinsed out. The solution is to be an ongoing, repurchased product for use with this system.

Ease of use is facilitated by the subject design. The user would simply fit the tube to a bottle of the cleansing solution, attach the tube connection to the tap fitting, and run the shower while the solution is being injected into the water stream. Cycling the showerhead through its various spray patterns, if it has more than one pattern, would provide thorough cleansing. Running the shower after the tube bas been removed will rinse out the remaining solution.

Alternate methods of providing the delivery system are contemplated including, but not limited to the use of aerosol cans or bottles, single dose systems, pellet systems, powder systems, no-pump aerosol sprays, large spray multi-dose systems, compact pump for travel, or a finger pump. If hotels have adapters pre-installed, travelers can carry their own solution and assure themselves of a clean shower whenever they want.

Also contemplated are single dose pumps, similar to a caulking gun as well as indicator dyes, soaps or markers of some kind.

Pellet systems can deliver sanitizer to be dissolved each time shower is used. A lever on the adaptor could route the water through the pellet chamber for cleansing, and when the lever is switched, water would bypass pellet and go through showerhead. Gravity or pump injection may also be utilized. To the same effect as the pellet system is a powder system wherein the sanitizer is used as a powder and a lever adaptor is provided to route water through the powder chamber and when the lever is switched, water would bypass the powder and go directly through the showerhead.

In other embodiments, bottles of solution stay attached and hang from adapter units near the showerhead and solution may be pumped into water flow with a button or lever attached to the bottle. A user would simply turn on the shower and pump the solution and the showerhead would be clean and rinsed of solution by the time water is warmed up.

A fitting to tap into the shower stub may also be utilized and would be similar to the piercing tap used to supply water to an ice maker in a refrigerator. The fitting has a hardened pierce valve that is driven into the pipe with a hand screw. A washer at the base of the pierce valve seals the pipe once it is seated. A hole through the middle of the pierce valve allows and controls access to the water stream.

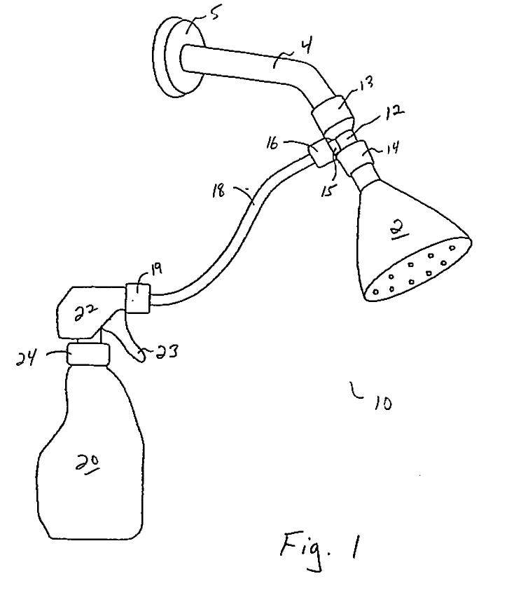

FIG. 1 is schematic representation of an embodiment of the subject sanitizing system 10 depicting a shower stub 4, a sanitizing adapter 12 having stub tap 15, a tube tap connection 16, a showerhead 2 and a bottle for supplying the cleaning agent solution. Sanitizing adapter 12 also has a supply port 15 which connects by tap 16 with supply tube 18 attached to spray bottle 20 via connector 19. Spray bottle 20 also has a conventional spray head 22 and spray trigger 23 which connects to spray bottle 20 by connector 24. In this figure wall plate 5 is affixed to stub 4, and threaded fitting 14 is used to attach showerhead 2.

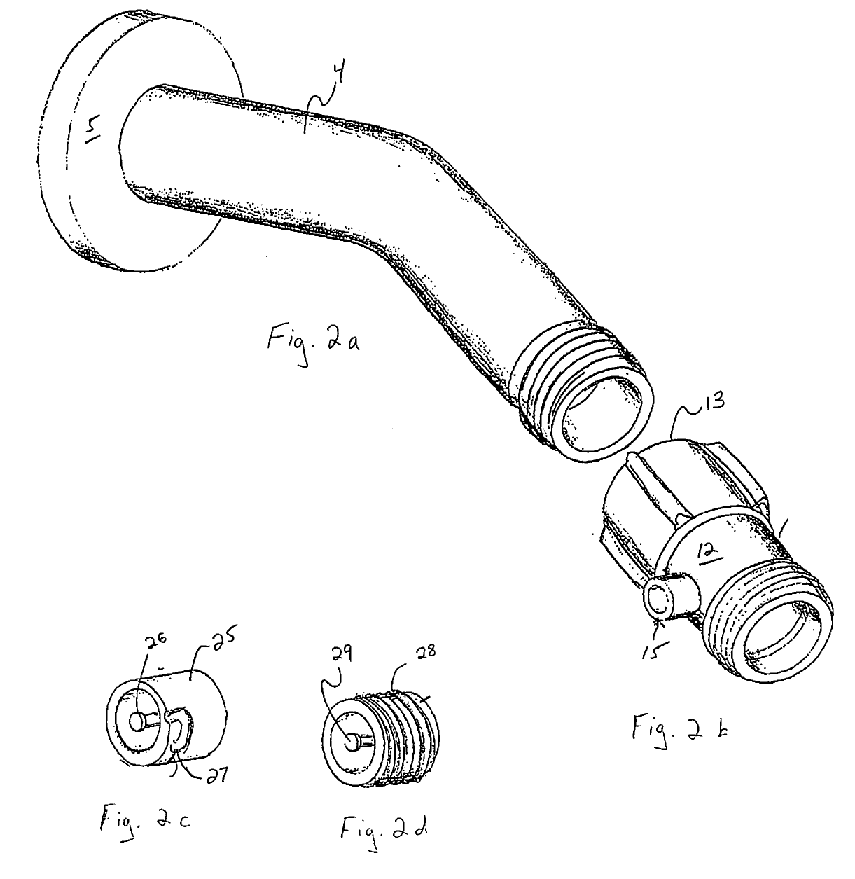

FIGS. 2a-d are perspective views of another embodiment of the subject sanitization system depicting a shower pipe stub 4 which is typically affixed to a shower wall covered by plate 5. In FIG. 2b, a hand tightened slip nut 13 allows proper orientation of adapter 12 and port 15. FIGS. 2c and 2d depict alternate Schrader valves which may be utilized. In FIG. 2c, valve 25 is of the quarter-turn type having detent 27 and actuating mechanism 26. FIG. 2d depicts threaded valve 28 having actuator pin 29.

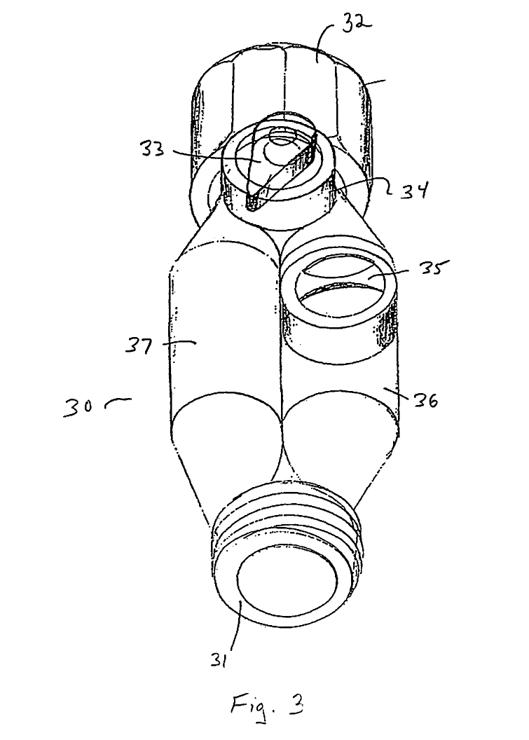

FIG. 3 is a perspective view of an alternative bypass adapter 30, which may be used in another embodiment of the subject system. Depicted is a pellet adapter slip nut 32 to attach to the stub (which allows adapter orientation). Also seen is a chamber hatch 35 with O-ring for inserting a sanitizing pellet, a pellet chamber ball valve selection lever 33 and lever housing 34 to direct flow through the pellet chamber 36 or through a bypass chamber 37, and a threaded fitting 31 for a showerhead.

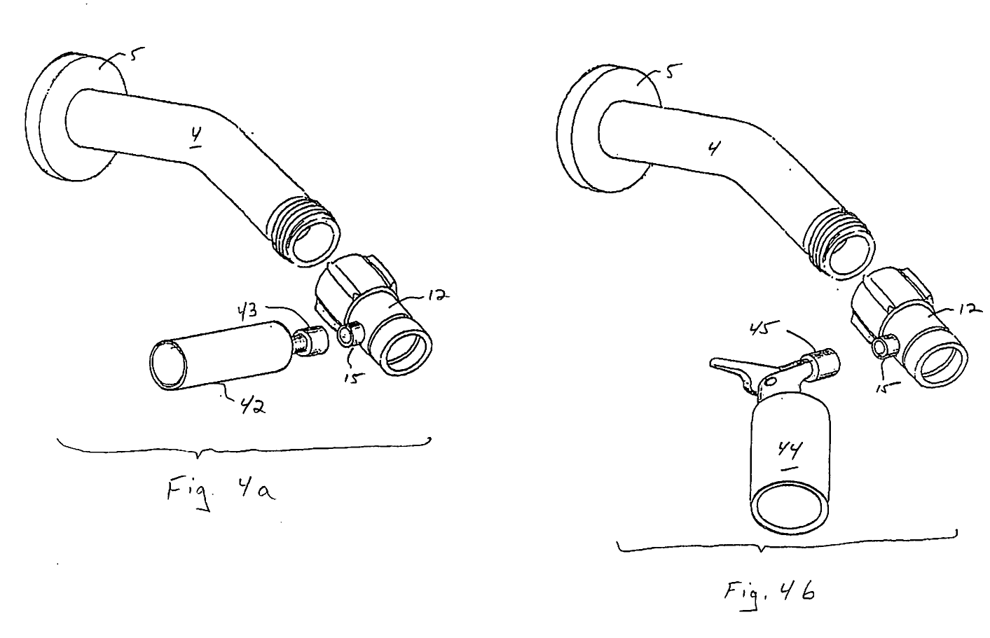

FIGS. 4a and 4b are perspective views of alternative sanitizer supply systems using adapters 12 with stubs 4. In FIG. 4a, supply cartridge 42 is used with supply fitting 43 attached directly to adapter 12 via supply port 15 without need of a supply hose. Similarly in FIG. 4b, pump actuated supply bottle 44 is attached to adapter 12 via supply port 15 with supply attachment fitting 45. FIG. 4a uses a compact aerosol or pump and is actuated by pushing the bottle into the tap.

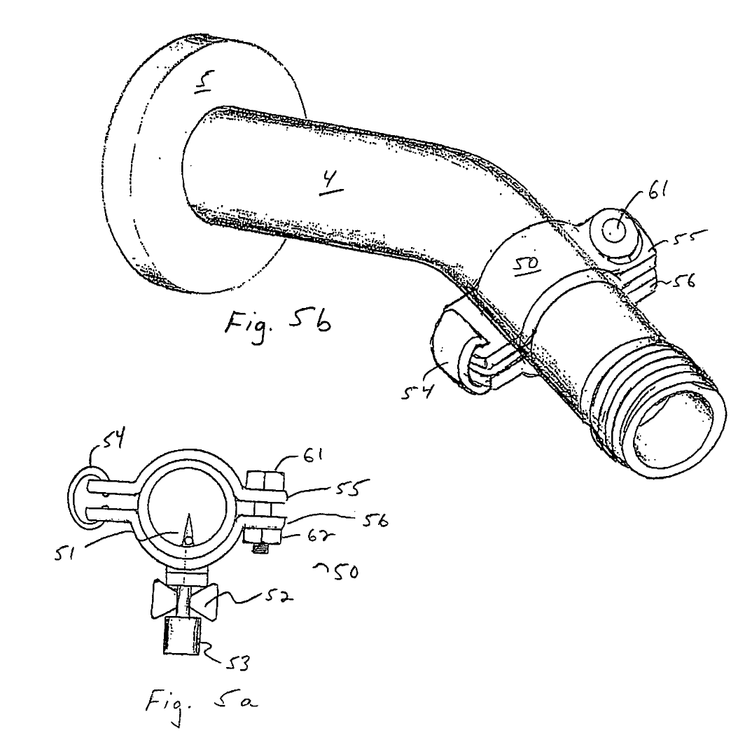

FIG. 5a is an end view of a pierce tap which may be used in another embodiment of the subject system. Depicted is a pierce tap 50 having pierce valve 51 which may be operated in conjunction with a Schrader valve and having adjustable wings 52, supply port 53, adjustment collar 54, tightening bolt and nut and 61-62 which maintain opposite valve sides 55 and 56 in position on a pipe stub.

FIG. 5b is a perspective view of a shower stub 4 combined with the pierce tap 50 shown in FIG. 5a.

It will be recognized that the component parts of the subject sanitizing system may be fabricated from metal or plastic parts suitable for use in plumbing applications. Such metals may include aluminum, copper, brass, bronze or steel as may be suitable in individual applications. Suitable thermoplastic resins for use in other applications may include nylons, polyesters, and any of a variety of reinforced thermoplastic resins.

The invention now being fully described, it will be apparent to one of ordinary skill in the art that many changes and modifications can be made thereto without departing from the spirit or scope of the invention set forth herein.

1. An apparatus for sanitizing plumbing fixtures comprising: a sanitizing adapter and/or tap port configured for attachment at one end to a water supply line and adapted for attachment at a generally opposite end of the adapter to a plumbing fixture, the adapter having a supply port for delivering a sanitizing or cleansing agent to the central body of the adapter and a water supply flowing therethrough and a mechanical control mechanism for permitting or preventing the supply of sanitizing agent to the water supply line.

2. An apparatus as in claim 1 wherein the adapter is attached to the water supply lines by threaded attachment.

3. An apparatus as in claim 1 wherein the plumbing fixture is a showerhead, shower hose or faucet.

4. An apparatus as in claim 1 wherein the sanitizing or cleansing agent is a liquid sanitizing or cleansing agent.

5. An apparatus as in claim 4 wherein the sanitizing or cleansing agent additionally contains at least one member of the group consisting of deodorizing agents, antimicrobials, anti-infectives, anti-molds and surfactants.

6. An apparatus as in claim 1 wherein the sanitizing adapter is a bypass adapter.

7. An apparatus as in claim 1 wherein a tap port is attached at one end to a water supply line and at the other end to a plumbing fixture.

8. An apparatus as in claim 5 wherein the sanitizing or cleansing agent is a solid pellet or powder sanitizing or cleansing agent.

9. An apparatus as in claim 1 wherein the supply port for delivering a sanitizing or cleansing agent to the central body of the adapter has a supply tube connected to a liquid sanitizing or cleansing agent.

10. An apparatus as in claim 1 wherein the supply port for delivering a sanitizing or cleansing agent to the central body of the adapter has a mechanical control mechanism for permitting or preventing the supply of sanitizing agent to the water supply line.

11. An apparatus as in claim 9 wherein the mechanical control mechanism is a Schrader valve.

12. A method of sanitizing a plumbing fixture comprising the steps of attaching a sanitizing adapter and/or tap port between a water supply line and a generally opposite plumbing fixture, wherein the adapter and/or tap port has a supply port for delivering a sanitizing or cleansing agent to the central body of the sanitizing adapter or tap port and a water supply flowing therethrough and a mechanical control mechanism for permitting or preventing the supply of sanitizing agent to the water supply line; adding a sanitizing or cleansing agent to the water supply;
and thereby sanitizing or cleansing the plumbing fixture.

13. A method as in claim 12 wherein the sanitizing or cleansing agent is a liquid sanitizing or cleansing agent.

14. A method as claimed in claim 13 wherein the sanitizing or cleansing agent additionally contains at least one member of the group consisting of deodorizing agents, antimicrobials, anti-infectives, anti-molds and surfactants.

15. A method as in claim 12 wherein the sanitizing adapter is a bypass adapter.

16. A method as in claim 12 wherein a tap port is attached between the water supply line and the plumbing fixture.

17. A method as in claim 14 wherein the sanitizing or cleansing agent is a solid pellet or powder-form sanitizing or cleansing agent.

18. A method as in claim 12 wherein the supply port for delivering a sanitizing or cleansing agent to the central body of the adapter has a supply tube connected to a liquid sanitizing or cleansing agent.

19. A method as in claim 12 wherein the supply port for delivering a sanitizing or cleansing agent to the central body of the adapter has a mechanical control mechanism for permitting or preventing the supply of sanitizing agent to the water supply line.

20. A method as in claim 18 wherein the mechanical control mechanism is a Schrader valve.

21. An apparatus as in claim 4 wherein the sanitizing or cleansing agent is a solid pellet or powder and is supplied to said supply port from a bottle or container adapted to formulate said sanitizing or cleansing solution in situ by mixing with water.
